(19) United States
(12) Patent Application Publication
(10) Pub. No.: US 2007/0062168 A1
(43) Pub. Date: Mar. 22, 2007

(54) Filter assembly for gas generating system

(76) Inventors: Chris A. Adamini, Shelby Township, MI (US); Christopher T. Sledz, Armada, MI (US)

Correspondence Address: L.C. Begin & Associates, PLLC, 510 Highland Avenue, PMB 403, Milford, MI, 48381, US

(21) Appl. No.: 11/523,439

(22) Filed: Sep. 18, 2006

Related U.S. Application Data
(60) Provisional application No. 60/718,891, filed on Sep. 19, 2005.

(51) Int. Cl. B01D 46/00

(52) U.S. Cl. 55/486

(57) ABSTRACT

A filter assembly usable in a gas generating system. The filter assembly includes a plurality of wrappable filter layer layers, each layer comprising at least one region of a material substantially impermeable to a flow of gases therethrough, and at least one region of a gas-permeable material coupled to the at least one region of substantially gas-impermeable material along an edge portion thereof. Each region of gas-permeable material in one filter layer is spaced apart from and opposite a region of substantially gas-impermeable material in an adjacent filter layer. The structures of the wrappable filter layers enable a tortuous gas flow path to be integrated into the filter media. A gas generating system, an airbag module, and a vehicle occupant protection system incorporating one or more wrappable filter layers are also described.

### CROSS REFERENCE TO RELATED APPLICATIONS

This application claims the benefit of provisional application Ser. No. 60/718,891, filed on Sep. 19, 2005.

### BACKGROUND OF THE INVENTION

The present invention relates to filters, and, more particularly, to filters for filtering combustion gases generated in a pyrotechnic gas generating system for use in applications such as inflatable occupant restraint systems in motor vehicles.

Continuing challenges in gas generator design are presented by the need to reduce the number of components in the gas generator and by the need to minimize the complexity of the filter incorporated in the gas generator for removing particulates and cooling generated gases. At the same time, filtering and cooling requirements must be met as determined by design criteria. To this end, it is frequently beneficial to incorporate into the gas generator a tortuous flow path for generated gases, thereby increasing the residence time of the gases within the filtration system and exposure of the gases to filter material. However, this necessitates the inclusion of baffles in the filtration system in addition to the filter material, which increases the weight, complexity, and part count of the gas generating system. In addition, some attempts to simplify the filter design have resulted in filter media being extruded into gas flow plenums formed in the system, thereby adversely affecting designed flow of the gases.

### SUMMARY OF THE INVENTION

The present invention provides a filter assembly for use in a gas generating system. The filter assembly includes a plurality of wrappable filter layer layers, each layer comprising at least one region or section of a material substantially impermeable to a flow of gases therethrough, and at least one region of a gas-permeable material coupled to the at least one region of substantially gas-impermeable material along an edge portion thereof. Each region of gas-permeable material in one filter layer is spaced apart from and opposite a region of substantially gas-impermeable material in an adjacent filter layer. The structures of the wrappable filter layers enable a tortuous gas flow path to be integrated into the filter media. A gas generating system, an airbag module, and a vehicle occupant protection system incorporating one or more wrappable filter layers are also described.

### BRIEF DESCRIPTION OF THE DRAWINGS

In the drawings illustrating embodiments of the present invention:

FIG. 1 is a side view of a first embodiment of wrappable filter layer in accordance with the present invention;

FIG. 2 is a side view of a second embodiment of wrappable filter layer in accordance with the present invention;

FIG. 3 is a cross-sectional view of a gas generating system incorporating an embodiment of a filter assembly in accordance with the present invention, utilizing wrappable filter layers as shown in FIGS. 1 and 2;

FIG. 4 is a schematic representation of an exemplary vehicle occupant restraint system incorporating a gas generating system including at least one wrappable filter layer in accordance with the present invention;

FIG. 5 is a side view of a third embodiment of wrappable filter layer in accordance with the present invention;

FIG. 6 is a side view of a fourth embodiment of wrappable filter layer in accordance with the present invention; and

FIG. 7 is a cross-sectional view of a gas generating system incorporating an embodiment of a filter assembly in accordance with the present invention, utilizing wrappable filter layers as shown in FIGS. 5 and 6.

### DETAILED DESCRIPTION

The present invention includes a wrappable filter layer and filter assembly for filtering combustion gases in a pyrotechnic gas generating system. By integrating both one or more regions of filtration material and one or more regions of gas impermeable material into a single-layered wrap, the wrap can perform the functions of both a baffle and a porous filter.

The Drawings show one embodiment of a filter assembly 10 according to the present invention. In the embodiment shown, filter assembly 10 includes an inner layer 12, an outer layer 14, and an intermediate region of filter material 16 positioned between inner layer 12 and outer layer 14.

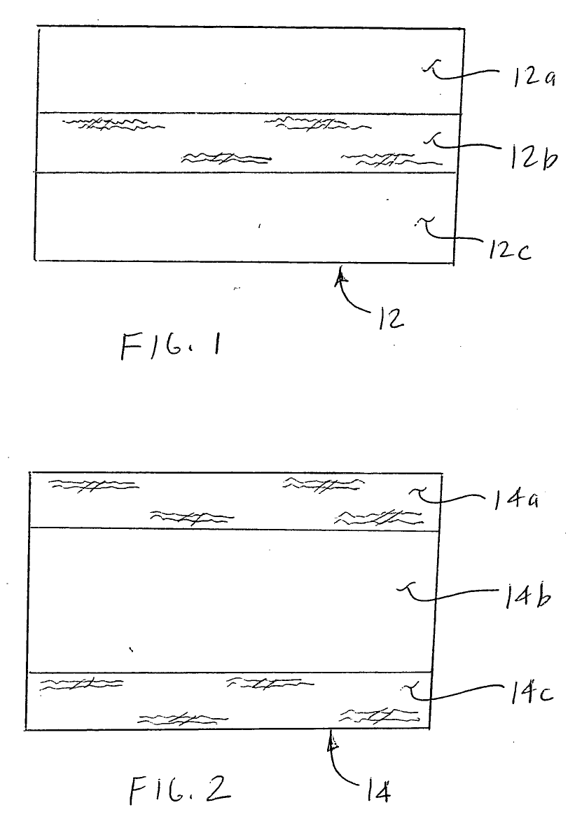

FIG. 1 shows one embodiment of the structure of inner layer 12. In the embodiment shown in FIG. 1, inner layer 12 comprises a first region 12a formed from a solid sheet material or other material substantially impervious to a flow of gases or other combustion products therethrough, a second region 12b formed from a sheet of mesh or other filter material which permits the flow of gases or other combustion products therethrough, and a third region 12c, also formed from a solid sheet material or other material substantially impervious to a flow of gases or other combustion products therethrough. Third region 12c may be formed from the same material as region 12a, or from a different material. Second region 12b is coupled to first region 12a and to third region 12c along edge portions thereof using one or more methods capable of producing seams between regions 12a and 12b and between regions 12b and 12c that are resistant to the flames, chemical by-products, and forces generated by combustion of a gas generant composition positioned adjacent inner layer 12. Any of a variety of methods may be used to couple together the adjacent regions, depending on factors such as, for example, the materials from which the adjoining regions are formed and the physical structure of second region 12b. Regions 12a, 12b, and 12c are coupled together at edges thereof as shown in FIG. 1 to form a sheet which is subsequently formed into a layer 12 configured to enclose a combustion chamber of a gas generating system 100. At least one wrappable filter layer constructed using the materials and methods described herein is incorporated into any embodiment of filter assembly 10.

Second region 12b of FIG. 1 may be formed from any of a variety of known, readily obtainable mesh or woven materials. For example, second region 12b may be formed from a sheet of expanded metal, such as a raised or flattened expanded metal sheet. In an embodiment where region 12b comprises mesh formed by cutting and/or stretching a single sheet of metal, end portions of the metal sheet may be retained in their solid form to produce fluid-impermeable regions 12a and 12c. Thus, regions 12a, 12b, and 12c may be formed monolithically with each other by cutting and stretching the central portion of a single metal sheet to produce second region 12b. Alternatively, second region 12b may be provided by forming perforations in a portion of a continuous, solid sheet to render the portion of the sheet fluid permeable.

In another embodiment, second region 12b is formed from a sheet of weld mesh constructed from metal wires formed into a mesh and welded at their intersections. The weld mesh of region 12b may be coupled to the metal sheets of regions 12a and 12c using any of a variety of methods. In one example, edge portions of the weld mesh are welded to corresponding edge portions of the fluid-impermeable metal sheets. In another example, one or more retention members (for example, clips, fasteners, or wires) may be provided to secure the mesh material to the sheet material. In one particular embodiment, one or more wires are passed through the mesh material and edge portions of the metal sheets are perforated to provide holes through which the wires may be passed to attach the edge portions of the mesh to the edge portions of the metal sheets.

In yet another embodiment, second region 12b is formed from woven or knitted wire (also known as wire cloth or wire gauze). The woven wire of region 12b may also be coupled to the fluid-impermeable sheets of regions 12a and 12c using any of a variety of methods. For example, wires may be passed through openings in edge portions of the mesh, and edge portions of the metal sheets are perforated to provide holes through which the wires are passed to attach the edge portions of the mesh to the edge portions of the metal sheets.

Second region 12b may also be formed from a non-metallic filtration material, such as a sheet of carbon fiber material. Edge portions of the carbon fiber sheet may be bonded (for example, using adhesives) to complementary edge portions of pieces of solid sheet material. Other suitable methods of coupling the carbon fiber to the fluid-impermeable sheets may also be used. However, as carbon fiber may react with aluminum or steel to cause cathodic corrosion of metal surfaces, it is advisable to interpose an insulating layer (comprised, for example, of fiberglass or some other suitable material) between the carbon fiber and any metal used to form the fluid-impermeable region, prior to securing the carbon fiber and metal together. Other structures and/or materials are contemplated for the gas-permeable regions(s) of the filter layer, provided that the gas-permeable structure and/or material used may be coupled to the substantially gas-impermeable region of the filter layer, and also provided that the structure and/or material used meets design requirements with regard to such factors as filtration and fluid flow characteristics. 5702-01131

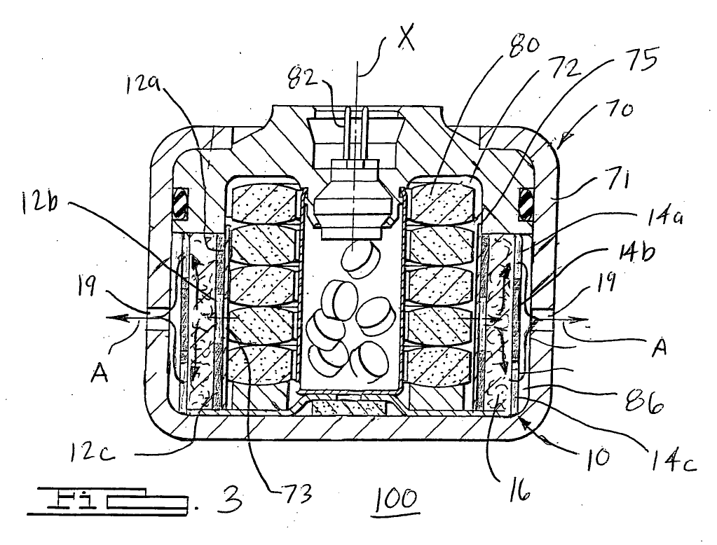

Referring now to FIG. 2, outer layer 14 may be constructed using the same materials and methods used in constructing inner layer 12. However, for purposes of defining a tortuous flow path for generated gases (as described in greater detail below), outer layer 14 is structured differently than inner layer 12.

FIG. 2 shows one embodiment of the structure of outer layer 14. Outer layer 14 comprises a first region 14a formed from formed from a sheet of mesh or other porous material which permits the flow of gases or other combustion products therethrough, a second region 14b formed from a solid sheet material or other material substantially impervious to a flow of gases or other combustion products, and a third region 14c, also formed from a sheet of mesh or other porous material which permits the flow of gases or other combustion products therethrough. Third region 14c may be formed from the same material as first region 14a, or from a different material. Second region 14b is coupled to first region 14a and to third region 14c along edge portions thereof using one or more methods capable of producing seams between regions 14a and 14b and between regions 14b and 14c that are resistant to the flames, chemical by-products, and forces generated by combustion of a gas generant composition positioned adjacent outer layer 14. Regions 14a, 14b, and 14c are coupled together at edges thereof as shown in FIG. 2 to form a sheet which is subsequently formed into a layer 14 configured to enclose a combustion chamber of gas generating system 100.

The materials and structures used for the mesh portions of layers 12 and 14 may depend of such factors as the temperature and composition of the combustion gases to be filtered, projected pressures of the combustion gases, and the sizes of the combustion particulates to be filtered. The meshes incorporated into layers 12 and 14 preferably have a substantially constant density, thus minimizing the risk that combustion gases will follow a path of reduced resistance rather than passing uniformly through the filter body. In addition, the dimensions of the gas-permeable portion (or portions) of the filter layer may be varied as desired to control the flow characteristics of the inflation fluid through the gas generating system.

As stated previously, an intermediate region of filter material 16 may be positioned between inner layer 12 and outer layer 14. Filter material 16 may comprise one or more layers of one or more of the conventional filter materials previously described (expanded metal mesh, weld mesh, woven wire, carbon fiber mesh) or other suitable filter materials. Although the embodiments of the wrappable filter layer described herein are shown incorporated into a driver-side gas generating system for an automotive vehicle, a wrappable filter structure as shown herein may be used in any other type of inflator (for example, a passenger-side inflator) or gas generating system where it is necessary to provide both filtration and a predetermined and/or tortuous flow path for generated gases.

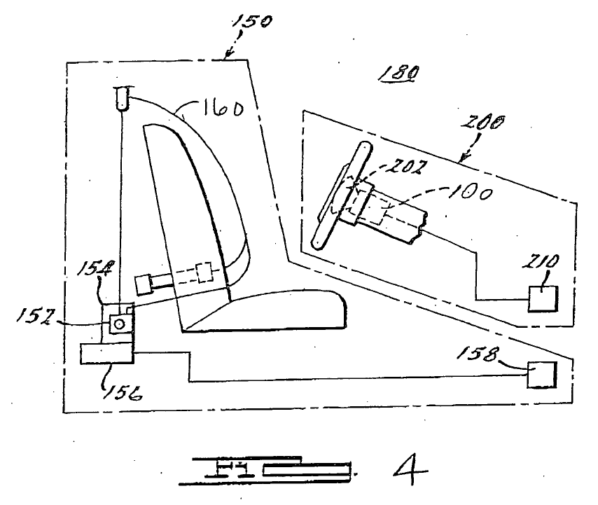

Referring now to FIG. 3, a filter assembly 10 in accordance with the present invention is positioned within an exemplary gas generating system assembly 100. Assembly 100 is used in an inflatable occupant restraint system in a motor vehicle. Assembly 100 is shown for illustrative purposes as a cylindrical inflator, contemplated primarily for driver side use. However, as stated above, it should be appreciated that the present invention is applicable to alternative inflator designs.

Assembly 100 includes a housing 70 having a wall 71 with at least one aperture 19 formed therein to enable fluid communication between an interior of housing 70 and an exterior of the housing. A combustion chamber 72 is formed by a cylindrical member 75 positioned in an interior of housing 70. Member 73 includes at least one aperture 73 formed therein to enable fluid communication between an interior of the combustion chamber and an exterior of the chamber. A gas generant composition 80 is positioned in combustion chamber 72 and is ignitable to provide inflation gas to the inflatable occupant restraint system. An igniter 82 is positioned to enable fluid communication with gas generant 80, for igniting the gas generant upon activation of the gas generating system. Filter assembly 10 is positioned external of cylindrical member 75, intermediate the aperture (or apertures) 73 in member 73 and the aperture (or apertures) 19 in inflator housing 70. A gas flow plenum 86 is formed between filter assembly and housing wall 71.

In the embodiment shown in FIG. 3, combustion chamber 72 is defined by cylinder 75 formed from steel or another metal positioned within housing 70. In an alternative embodiment, cylinder 75 is eliminated and the combustion chamber is formed by filter assembly 10 enclosing a gas generant composition 76 within a cylinder formed by inner layer 12. Elimination of the separate steel cylinder 75 reduces the weight of the gas generating system, the number of parts required for assembly, and the complexity of the gas generating system.

FIG. 3 also shows operation of the gas generating system.

Gases generated by the combustion of the gas generant in chamber 72 are directed outwardly, along a path described by arrows “A” passing through filter assembly 10 and exiting the gas generating system 71 via housing apertures 19. As seen in FIG. 3, mesh portions 14a, 14c of outer layer 14 are positioned radially spaced apart from and opposite solid portions 12a, 12c of layer 12, and mesh portion 14b of layer 14 is positioned radially spaced apart from and opposite solid portion 12b of layer 12. As seen from the arrows in FIG. 3 representing the flow directions of generated gases, this arrangement of layers 12 and 14 provides a tortuous flow path of gases from combustion chamber 72 to gas exit apertures 19, for cooling and filtering the gases. The incorporation of additional filtering material 16 between layers 12 and 14 provides an additional measure of cooling and filtering.

Referring to FIG. 4, any embodiment of the gas generator described herein may be incorporated into an airbag system 200. Airbag system 200 includes at least one airbag 202 and a gas generating system 100 as described herein coupled to the airbag so as to enable fluid communication with an interior of the airbag. Airbag system 200 may also be in communication with a known crash event sensor 210 that is in operative communication with a known crash sensor algorithm (not shown) which signals actuation of airbag system 200 via, for example, activation of igniter 82 (not shown in FIG. 4) in the event of a collision.

Referring again to FIG. 4, an embodiment of the gas generator or an airbag system including an embodiment of the gas generator may be incorporated into a broader, more comprehensive vehicle occupant restraint system 180 including additional elements such as a safety belt assembly 150. Safety belt assembly 150 includes a safety belt housing 152 and a safety belt 160 extending from housing 152. A safety belt retractor mechanism 154 (for example, a spring-loaded mechanism) may be coupled to an end portion of the belt. In addition, a safety belt pretensioner 156 may be coupled to belt retractor mechanism 154 to actuate the retractor mechanism in the event of a collision. Typical seat belt retractor mechanisms which may be used in conjunction with safety belt 160 are described in U.S. Pat. Nos. 5,743,480, 5,553,803, 5,667,161, 5,451,008, 4,558,832 and 4,597,546, incorporated herein by reference. Illustrative examples of typical pretensioners with which safety belt 160 may be combined are described in U.S. Pat. Nos. 6,505,790 and 6,419,177, incorporated herein by reference.

Pretensioner 156 may be in communication with a known crash event sensor 158 (for example, an inertia sensor or an accelerometer) that is in operative communication with a known crash sensor algorithm (not shown) which signals actuation of belt pretensioner 156 via, for example, activation of a pyrotechnic igniter (not shown) incorporated into the pretensioner. U.S. Pat. Nos. 6,505,790 and 6,419,177, previously incorporated herein by reference, provide illustrative examples of pretensioners actuated in such a manner.

The construction of filter assembly 10 is described above. It will be appreciated that the various other constituents of the gas generating system are formed in known manners. For example, the portions of housing 70 may be molded, stamped, drawn, or otherwise metal formed from carbon steel, aluminum, metallic alloys, or polymeric equivalents.

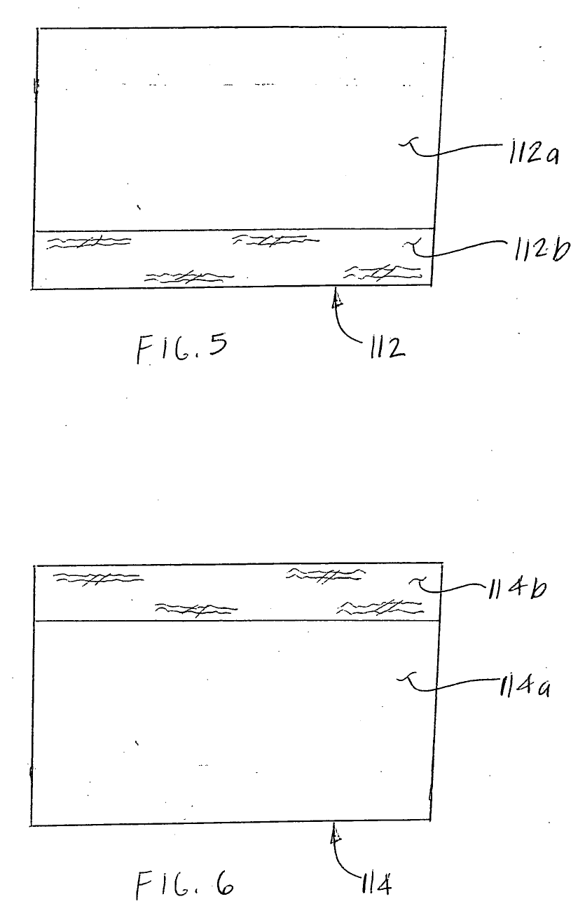

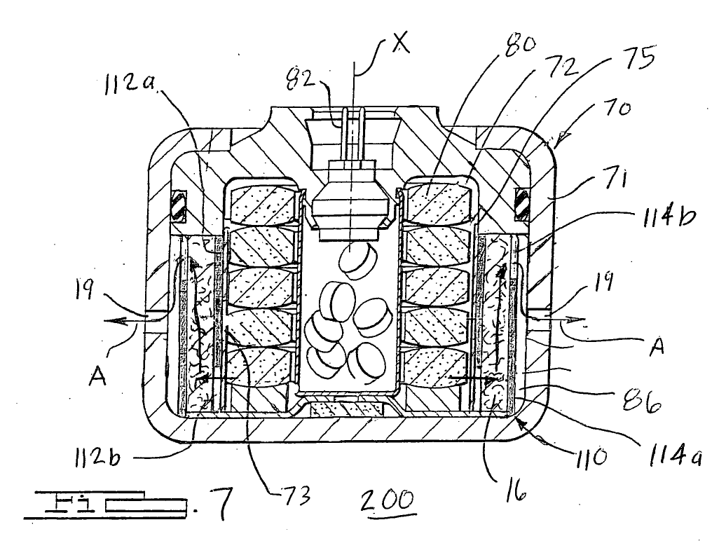

Referring now to FIGS. 5-7, in alternative embodiments of the filter layers and the filter assembly, inner filter layer 112 and outer filter layer 114 are formed using one or more of the same methods and materials used in constructing filter layers 12 and 14 previously described. However, in the embodiments shown in FIGS. 5-7, filter layer 112 includes a single region 112a which is substantially impermeable to a flow of gases or other combustion products therethrough, and a single fluid permeable region 112b. Similarly, filter layer 114 includes a single region 114a which is substantially impermeable to a flow of gases or other combustion products therethrough, and a single fluid permeable region 114b. When incorporated into a filter assembly 110 in a gas generating system 200 as shown in FIG. 7, filter layers 112 and 114 form an integral tortuous fluid flow path through the filter assembly, as shown in FIG. 7. Also, as in the previously described embodiments, an intermediate filter material layer 16 may be incorporated into filter assembly 110 between wrappable layers 112 and 114.

In yet another aspect of the invention, it may be seen from FIGS. 3 and 7 that the gas-permeable and substantially gas-impermeable regions the respective inner filter layers 12,112 and outer filter layers 14,114 are coupled together such that, when incorporated into a filter assembly as shown in FIGS. 3 and 7, the filter layers combine to form respective baffle structures which direct the flow of combustion products in directions generally parallel with an axis X of the gas generating system.

Integrating a tortuous gas flow path into the filter media as described herein obviates the need for a separate baffle system to direct the gas flow. In addition, extrusion of filter media into gas flow plenum 86 between the filter assembly and housing wall 71 and into apertures 19 in housing wall 17, caused by supersonic gas flow exiting the gas generating system, may be prevented. Also, both the complexity of the gas generating system and number of parts required for assembly of the gas generating system are reduced. Finally, the variability in the output properties of the generated gases is also reduced.

Although the embodiments described herein utilize a pair of wrappable filter layers 12 and 14 in forming the filter assembly, a filter assembly may be constructed utilizing any desired number of wrappable filter layers, to provide a desired residence time of gases within the inflator and/or a desired level of particulate filtration according to design requirements.

It will be understood that the foregoing description of embodiments of the present invention is for illustrative purposes only. As such, the various structural and operational features herein disclosed are susceptible to a number of modifications commensurate with the abilities of one of ordinary skill in the art, none of which departs from the scope of the present invention as defined in the appended claims.

What is claimed is:

1. A wrappable filter layer comprising:
at least one region of a material substantially impermeable to a flow of gases therethrough; and
at least one region of a gas-permeable material coupled to the at least one region of substantially gas-impermeable material along an edge portion thereof.

2. The filter layer of claim 1 further comprising at least one additional region of substantially gas-impermeable material coupled to the at least one region of gas-permeable material along an edge portion thereof.

3. The filter layer of claim 2 wherein the at least one additional region of substantially gas-impermeable material is a material different from the at least one region of substantially gas-impermeable material.

4. The filter layer of claim 1 further comprising at least one additional region of gas-permeable material coupled to the at least one region of substantially gas-impermeable material along an edge portion thereof.

5. The filter layer of claim 4 wherein the at least one additional region of gas-permeable material is a material different from the at least one region of gas-impermeable material.

6. The filter layer of claim 1 wherein the gas-permeable material comprises a welded wire mesh.

7. The filter layer of claim 1 wherein the gas-permeable material comprises a carbon fiber material.

8. The filter layer of claim 7 further comprising an insulating layer positioned between the gas-permeable material and the substantially gas-impermeable material to prevent contact therebetween.

9. The filter layer of claim 8 wherein the insulating layer comprises fiberglass.

10. The filter layer of claim 1 wherein the at least one region of a gas-permeable material is coupled to the at least one region of substantially gas-impermeable material by welding.

11. The filter layer of claim 1 wherein the at least one region of a gas-permeable material is coupled to the at least one region of substantially gas-impermeable material by at least one retention member.

12. The filter layer of claim 11 wherein at least one opening is formed in at the least one region of substantially gas-impermeable material, and wherein the at least one retention member comprises a wire extending through both the at least one region of gas-permeable material and the at least one opening to connect the at least one region of substantially gas-impermeable material to the at least one region of gas-permeable material.

13. A gas generating system including at least one wrappable filter layer according to claim 1.

14. An airbag module comprising a gas generating system including at least one wrappable filter layer according to claim 1.

15. A vehicle occupant protection system comprising a gas generating system including at least one wrappable filter layer according to claim 1.

16. A filter assembly comprising:
a plurality of wrappable filter layer layers, each layer comprising at least one region of a material substantially impermeable to a flow of gases therethrough, and at least one region of a gas-permeable material coupled to the at least one region of substantially gas-impermeable material along an edge portion thereof, wherein each region of gas-permeable material in one layer is spaced apart from and opposite a region of substantially gas-impermeable material in an adjacent layer.

17. The filter assembly of claim 16 further comprising at least one layer of filter material positioned between a pair of adjacent wrappable filter layer layers.

18. The filter layer of claim 17 wherein the at least one layer of filter material comprises knitted wire.

19. The filter layer of claim 1 wherein the gas-permeable material comprises expanded metal.

20. The filter layer of claim 1 wherein the gas-permeable material comprises perforated metal.

21. The filter layer of claim 1 wherein the at least one region of a gas-permeable material is coupled to the at least one region of substantially gas-impermeable material so as to direct a flow of combustion products in a direction generally parallel with an axis of the gas generating system.

22. The filter assembly of claim 16 wherein the regions of gas-permeable material are coupled to respective regions of substantially gas-impermeable material such that a flow of combustion products is directed through the filter assembly in directions generally parallel with an axis of the gas generating system.
